(19) United States
(12) Patent Application Publication
(10) Pub. No.: US 2023/0076685 A1
(43) Pub. Date: Mar. 9, 2023

(54) SYSTEMS AND METHODS FOR PRODUCING PERMANENT MAKEUP DESIGNS

(71) Applicant: Timothy Cargle, Kettering, OH (US)

(72) Inventor: Timothy Cargle, Kettering, OH (US)

(21) Appl. No.: 17/890,250

(22) Filed: Aug. 17, 2022

Related U.S. Application Data
(60) Provisional application No. 63/211,601, filed on Jun. 17, 2021.

(51) Int. Cl. G06T 11/00; G06Q 30/06

(52) U.S. Cl. CPC G06T 11/00; G06Q 30/0621; G06Q 30/0643; G06T 2200/24

(57) ABSTRACT

Embodiments described herein relate to a real time, augmented reality, permanent makeup filter to facilitate a preview of what a person could look like with permanent makeup design such as scalp micropigmentation and/or permanent eyebrows replacing a subject's hair or eyebrows with a filtered version, without uploading a photo or having to edit the photo. Based on a scan of the subject's head/face, a system can determine measurements associated with features of the subject's head/face and determine targets for the application of the permanent makeup design. In one embodiment, a system facilitates a customer providing input into the permanent makeup design, such that the permanent makeup design is produced in consultation with a specialist (via a web facility, for example). The system facilitates making adjustments to the design by both a customer and the specialist, simultaneously and in real time, during the consultation.

### CROSS-REFERENCE TO RELATED APPLICATIONS

The present application claims priority to U.S. Provisional Patent Application No. 63/211,601 filed Jun. 17, 2021, entitled “SYSTEMS AND METHODS FOR PRODUCING PERMANENT MAKEUP DESIGNS” which is hereby incorporated by reference in its entirety.

### FIELD

Embodiments of the invention relate generally to system and methods for facilitating production of permanent makeup designs. In particular, embodiments of the invention are directed to systems and methods of using augmented reality, a scan of a subject's head, and program modules to produce permanent makeup designs.

### BACKGROUND

Permanent makeup is a cosmetic technique that uses permanent pigmentation of the dermis for producing designs that resemble makeup, such as eyelining and other permanent enhancing colors to the skin of, for example, the face, lips, and eyelids. It is also used to produce artificial eyebrows and to disguise scars and white spots in the skin. It is also used to restore or enhance the breast's areola, such as after breast surgery. Most commonly called permanent cosmetics, other names include dermapigmentation, micropigmentation, and cosmetic tattooing.

People suffering from hair loss, hair thinning, or eyebrow issues, often cannot tell if permanent makeup can be a good fit for them, and this creates unease in potential customers since the results of the procedure are permanent. Often customers are unsatisfied with the permanent makeup procedures they receive because the customers had difficulty knowing what the designs would look like until the designs were implemented on the customers.

Under known techniques, customers often do not participate when it comes to the design process. Most customers are shown what a design looks like from images of models. This method is unreliable and inaccurate. This experience is similar to the experience of people needing to try on clothes at stores. Clothes can look good on a mannequin, but when a customer tries the clothes at home (that is, the customer did not try the clothes on at the store), the customer is unsatisfied with how the clothes look on them. The experience of implementing a permanent makeup procedure can be the same way. Currently, known techniques do not enable a permanent makeup specialist to know the actual design that a customer wants without guessing. Moreover, the state of the art fails to allow customers to significantly participate in the design process of the permanent makeup procedure.

In some cases, customers book consultations for permanent makeup but often have to cancel at the last minute for various reasons (for example, cannot find a baby sitter, car trouble, unexpected work obligation, and the like). This is a detriment to a permanent makeup specialist hanging because the specialist could have filled that spot with another customer.

Known systems require a potential customer to upload a photo, then a specialist edits the photo to the best of their ability based on what the specialist thinks looks good. Additionally, known systems place computer generated eyebrows and micropigmentation over a customer's existing hair (head or eyebrow), and thereby create an inconsistent look. The resulting image is significantly distorted and unrealistic.

In known systems, the customer typically goes to an office or makes a video call for a consultation. The specialist then shows the customer before and after pictures of other work they have done to give the customer an idea of what the design could be. This leaves the customer guessing what the procedure might look like on the customer. Customers are often unsatisfied with the results the procedure because the work they saw on other customers does not fit them. Every procedure is unique to the specific customer.

Currently, the state of the art fails to facilitate a customer and a specialist to both work the design simultaneously, in real time, while the design appears on the customer's face or head. Known systems use editing tools (such as Photoshop) to create the design. Such editing tools are typically inaccurate and only available to the specialist, which leaves the customer out of the process of creating the design.

Most customers are not photographers. To upload the right picture, the lighting has to be right, the angle has to be adequate, and the camera has to have adequate resolution. The customer depends on the specialist to produce a design that matches what the customer thinks looks right. The customer typically has to wait until the specialist has time to edit the photo. Editing photos is not effective, efficient or reliable. It is all guess work. There is no accurate measuring of the face or head.

There continue to exist needs in the permanent makeup field to facilitate the collaborative production of a design that is realistic to the final result of the procedure on a specific customer. Embodiments of inventive systems and methods disclosed here address at least some of these needs.

### SUMMARY OF THE INVENTION

In one embodiment, the invention concerns a system for producing a permanent makeup design for application to a subject's head/face. The system can include an application server computer having a processor, a memory, and a network interface. The system can further include one or more computer program modules stored in said memory, the modules configured to: produce a scan of the subject's head; display the subject's head with an augmented reality filter, said display performed in communication with a specialist interface of a specialist device and/or a customer interface of a customer device; based on said scanning, determine measurements associated with the subject's head/face; based on said scanning, determine targets of the subject's head/face for the application of the permanent makeup design; receive from the customer interface a customer input associated with the permanent makeup design; receive from the specialist interface a specialist input associated with the permanent makeup design; facilitate communication between the customer device and the specialist device to provide for simultaneous collaboration, in real time, between a user of the customer device and a user of the specialist device in the creation of the permanent makeup design; and display the subject's head/face: (a) using the augmented reality filter, (b) with the existing hair virtually removed from the subject's head/face, and (c) the permanent makeup design replacing the targets, wherein the display is performed in communication with the specialist device and/or the customer device. In some embodiments, the targets can include eyebrows, scars, bald spots, or thinning spots on the subject's head/face. In certain embodiments, the customer input and/or the specialist input is associated with an adjustment of size, shape, and/or color of the permanent makeup design.

In another aspect, the invention is directed to a method of producing a permanent makeup design for a subject. The method can involve producing a scan of the subject's head/face; displaying the subject's head/face with an augmented reality filter; based on said scanning, determining measurements associated with the subject's face/head; based on said scanning, determining targets of the subject's head/face for the application of the permanent makeup design; providing a customer interface for receiving customer input associated with the permanent makeup design; providing a specialist interface for receiving specialist input associated with the permanent makeup design; wherein the customer interface and the specialist interface are configured to facilitate a customer and a specialist to collaborate simultaneously, in real time, in the creation of the design; wherein the customer input and/or the specialist input are configured to facilitate an adjustment of size, shape, and/or color of the design; and displaying the subject's head/face (a) using the augmented reality filter, (b) with the existing hair virtually removed, and (c) the permanent makeup design replacing the targets. In some embodiments, the method further includes providing a camera for taking a picture of the subject's head/face. In certain embodiments, determining targets includes determining scars, bald spots, eyebrows, or thinning spots on the subject's head/face. In one embodiment, the customer input and/or the specialist input is associated with an adjustment of size, shape, and/or color of the permanent makeup design.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 is a block diagram of a computer system that can be used to produce permanent makeup designs according to some embodiments;

FIG. 2 is a diagram of an exemplary method that can be used to produce permanent makeup designs according to some embodiments;

FIG. 3 illustrates a block diagram of the computing system and application program, according to some embodiments;

FIG. 4 illustrates a screenshot of the micro blading interface, according to some embodiments;

FIG. 5 illustrates a screenshot of the micro blading interface, according to some embodiments;

FIG. 6 illustrates a screenshot of the micro blading interface, according to some embodiments;

FIG. 7 illustrates a screenshot of the micro blading interface, according to some embodiments;

FIG. 8 illustrates a screenshot of the micro blading interface, according to some embodiments;

FIG. 9 illustrates a screenshot of the micro pigmentation interface, according to some embodiments;

FIG. 10 illustrates a screenshot of the micro pigmentation interface, according to some embodiments;

FIG. 11 illustrates a screenshot of the micro pigmentation interface, according to some embodiments;

FIG. 12 illustrates a screenshot of the micro pigmentation interface, according to some embodiments;

FIG. 13 illustrates a screenshot of the micro pigmentation interface, according to some embodiments;

FIG. 14 illustrates a screenshot of the micro pigmentation interface, according to some embodiments; and

FIG. 15 illustrates a screenshot of the micro pigmentation interface, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

In general, the embodiments described herein relate to a real time, augmented reality permanent makeup filter to facilitate seeing what a person could look like with scalp micropigmentation (“SMP”) and/or permanent eyebrows replacing the existing hair or eyebrows with a filtered version without uploading a photo or having to edit the image (with Photoshop, for example). Permanent eyebrow procedures include microblading, microshading, Ombré brow, powder brow, and microfeathering, for example.

In one embodiment, the system facilitates seeing what a person would look like with a permanent makeup design. After a customer selects a design, a consultation can be scheduled or an instant consultation can take place with a specialist (via a web facility, for example). The system can facilitate making adjustments desired by both the customer and a specialist during the consultation. After a final design decision is made, the customer can schedule a procedure and prepay for the procedure through the system.

People suffering from hair loss of hair thinning, or eyebrow issues, do not know if permanent makeup can be a good fit for them since it's a permanent procedure. Customers are often unsatisfied with the permanent makeup procedures they receive because the customers do not know what the design would look like until they actually receive the procedure.

Customers often do not participate when it comes to the design process. Most customers are shown what a design looks like from images of models. This method is unreliable and inaccurate. That's why people try on clothes at the department stores. Clothes can look good on a mannequin, but when the customer tries the clothes at home (customer did not try the clothes on at the store) the customer is unsatisfied with how the clothes look on them. Permanent makeup can be the same way.

Customers book consultations but often have to cancel at the last minute for various reasons (cannot find a baby sitter, car trouble, unexpected work obligation, and the like). This is a disadvantage to the specialist because they could have filled that spot with another customer.

In one embodiment, the system uses an augmented reality filter that produces different shapes, sizes, colors and patterns that represent permanent makeup (for example, micropigmentation, microblading, or microshading). The system provides a filter that can be used to facilitate a decision to get a procedure that has permanent results.

In one embodiment, the system blocks out the existing hair or eyebrows and only shows the computer generated design. This helps create a true look and feel without significant distortion.

In one embodiment, the system facilitates a specialist to know the actual design that the customer wants without guessing. The system facilitates allowing a customer to significantly participate in the design process of the permanent makeup procedure.

The system facilitates preventing buyer's remorse. Many customers are dissatisfied with the results of permanent makeup procedures. A specialist can verbally explain what a design will look like, or even show examples, but unless the customer can see the design on the customer, the customer does not really know what the customer is getting.

The system facilitates creating a user flow that includes, for example: seeing before buying; speaking with a specialist virtually (cuts down on office visits); customer and specialist customizing the procedure together in real time, and prepaying for the procedure (this helps the specialist not waste their time on window shoppers and people wasting time by not showing up for the procedures).

Known systems require a potential customer to upload a photo, then a specialist edits the photo to the best of their ability based on what the specialist thinks looks good.

Known systems place the computer generated eyebrows and micropigmentation over the client's existing hair (head or eyebrow), thereby creating an inconsistent look. The image is significantly distorted and unrealistic.

In known systems, the customer typically goes to an office or makes a video call for a consultation. The specialist then shows the customer before and after pictures of other work they have done to give the customer an idea of what the design could be. This leaves the customer guessing what the procedure might look like on the customer. Customers are often unsatisfied with the results the procedure because the work they saw on other customers does not fit them. There is currently no way for a customer and specialist to both work the design simultaneously while the design appears on the customer's face or head.

Known systems use editing tools (such as Photoshop) to create the design. Such editing tools are typically inaccurate and only available to the specialist, which leaves the customer out of the process of creating the design.

Most customers are not photographers. To upload the right picture, the lighting has to be right, the angle has to be adequate, and the camera has to have adequate resolution. The customer often has no input on the creation of the design. The customer depends on the specialist to produce a design that matches what the customer thinks looks right. The customer typically has to wait until the specialist has time to edit the photo.

When a specialist shows a customer a design that the specialist has performed on another customer, the customer does not know what the customer will look like with the same design. Every procedure is unique to the specific customer. Also the customer has no idea of what the design will look like on the customer until the (permanent) design is implemented. Because the procedure is permanent, there is no way to protect the customer.

Editing photos is not effective, efficient or reliable. It is all guess work. There is no accurate measuring of the face or head. In one embodiment, without uploading pictures of the customer, the system allows the customer to see what the customer would look like. With the live filter, a customer sees in real time adjustments such as size, color, and/or shape.

In inventive embodiments disclosed here, the measurements and algorithms produce a more accurate look that shows the customer the details of a potential procedure before the customer decides to buy.

In certain embodiments, the system is advantageous to a specialist because the specialist does not have to guess what the customer wants. The system can facilitate the customer and the specialist to collaborate simultaneously to create the design before any work on the customer is done. In one embodiment, the system facilitates the specialist to make adjustments to the design during a video conference with the customer. This cuts down on in-person consultations, unsatisfied customers, and wasted time.

Currently, the specialist requests the customer to upload a photo of the customer. Then the specialist edits the photo to the best of the specialist's ability. This process is highly inaccurate and can mislead the customer. In some cases, when a filtered version is presented, the design is pasted over the customer's existing hair or eyebrows producing a distorted look.

In one embodiment, the system includes a computing device (such as a phone, tablet, laptop computer, desktop computer), a camera (which can be integrated with the device), a user interface (screen, keyboard, mouse, and the like), and program modules. The program modules can include logic for producing a digital scanning of a person's face (including, for example, eyes, forehead, mouth, nose, cheeks, and/or head). The program modules can further include an augmented reality filter, and logic for finding (a) eye brow measurement, and (b) bald or thinning spots. The program modules can also include logic for replacing said spots with, for example, a micropigmentation design. In some embodiments, the system can be implemented as a web based application and/or a mobile application.

In one embodiment, a customer provides a username and password to access a Customer Profile. The Customer Profile can include pictures that the customer has taken from the camera within the application. In some embodiments, depending on the subscription services a specialist has access to, all of the features from said subscription services are available for the customer to customize a design with different options.

In some embodiments, the system is configured to display notifications and/or email to the customer. In one embodiment, the customer can initiate a video call with the specialist if the specialist has an availability sign turned on. In certain embodiments, the system is configured to facilitate the Customer paying for any consultations or procedures through an online payment processor.

In one embodiment, the method include displaying a welcome video and providing a button with a call to action. When said button is clicked a login interface is provided. The login interface can provide an option to create a demonstration option to “try now”.

When a user selects the “try now” option, the system can request input associated with the subject's gender (for example, male or female). After gender selection, the system can provide the user with a button and/or a check box to “accept terms and conditions”. After accepting the terms and conditions, the guest selects the available service, which depends on the service the specialist has subscribed to (for example, micropigmentation and/or Permanent Eyebrows).

After the service is chosen, guest looks into the device camera, and the filter digitally measures and scans the guest face or head and shows either SNIP or permanent eyebrows.

After the system has a scan of the service area design, the guest's natural hair or eyebrows are removed and replaced with the digital version provided by the system.

For example, if guest selects Eyebrows, then the guest's natural eyebrows disappear as though the guest did not have any eye brows, and the permanent makeup eyebrows are shown. (This process should happen all at once).

In one embodiment, the system can have functionality to facilitate the guest to create a design. Said functionality can include selecting eyebrow type (for example, microshading, microblading, powder brow, Ombré brow, or microfeathering plus microshading, or microblading plus microshading). The system can provide functionality for selecting eyebrow shapes (for example, straight, curved, soft arch, high arch, “S” shaped, upward). The system can further include functionality for selecting eyebrow color (for example, ash brown, grey, blonde, medium brown, dark brown, bold brown, or ebony). The system can further include functionality for selecting eyebrow size (for example, width or length). In one embodiment, eyebrow size can be selected using a sliding control button (similar to a digital volume button), for example. In certain embodiments, when adjusting eyebrow size, both eyebrows can adjust together to keep them symmetrical.

After the guest has completed a design, the guest can take a picture from the camera within the application. The picture can have 360-degree view to show front, top, and back of the head.

If the guest selects SMP, then the guest can select a gender (for example, male or female). Depending on the option the guest selects, the system provides an avatar head (male or female) displaying the most common areas of hair loss (male pattern baldness and female pattern baldness). The guest selects which part(s) of the head the guests has trouble with (for example, temple, crown, right side, left side, back, whole head, or beard). Based on the troubled areas a procedure type can be suggested. Suggest buzz cut for scar treatment only, Norwood 2-3 (hairline and crown work only); standard procedure; standard procedure plus scar work; mild Alopecia; and severe alopecia (whole head). For women's hair loss, keep existing hair on display. For adding density (crown or thinning hair), display buzz cut and existing hair option side by side. In one embodiment, the digitally generated design suggested can be shown next to the procedure type.

In one embodiment, the system facilitate selection of a pigment color, which can include, for example, light brown, dark brown, or black.

A guest can select the buzz cut or a density fill of existing hair. For the density option, selections can include, for example, light, medium, or dark. A guest can further select a hairline type such as, for example, razor line or feathered. A guest can further select a hairline style such as, for example, straight, slightly curved, or custom (a control facilitates moving a digital dial to customize points on the hairline).

After selecting a troubled area, the guest looks into the camera to start the scan. In one embodiment, the existing hair can be blotted out and a SMP buzz shown. The customer can select to use their existing hair and add more density. Most women do not desire a buzz cut, therefore their existing hair is not blotted out, and the SMP design can be added to the scalp to give the density fill design.

In some embodiments, before a customer speaks to a specialist, the customer can provide their name, phone number (a code can be sent to their text message that the customer can provide back to the system to verify their phone number), email, date of birth (to make sure they are 18 years or older), username (email), and password.

In certain embodiments, after the guest selects a design and takes their photo with the chosen filter on their face or head, the guest can select to speak with a specialist at that time or schedule a consultation for a later time. In one embodiment, a guest can schedule a free consultation (however, an option can be provided for the specialist to add a consultation fee if desired). In some embodiments, the guest can schedule an in-person or a web conference consultation. In some embodiments, the guest can be instantly connected to a specialist. The specialist can select to turn this feature on or off If the feature is on, the specialist receives a notification that a customer is requesting to speak with them (this can be accomplished through web conferencing, for example˜similar to how a doctor web conferences with a patient).

In one embodiment, the system facilitates a guest selection to schedule a web conference or a consultation, the features from the services that a particular specialist has access to are available for both the guest and the specialist to work through the design together during a video call. The services can include, for example, selection of hairline style and type, SMP type, pigment color, density, and the like; selection of the eyebrow features. In some embodiments, the system facilitates the guest to schedule a procedure and pay for it through the application, or if in cash the in-person.

In one embodiment, when a guest uses the filter, the system facilitates a guest to store a photo of what they look like. The system can store a photo of them without the filter, then a photo while using the filter. Hence, the guest has a before-picture and an after-picture, side by side, to compare to.

In some embodiments, the system can facilitate a specialist to track each customer profile, and to book consultations and procedures with a scheduling tool. In one embodiment, the system can provide the specialist with a message or notification area for the specialist to keep up to date on any updates or to receive messages.

In certain embodiments, the system can facilitate the specialist to schedule a free consultation (however, the system can provide an option for the specialist to add a consultation fee). In one embodiment, the system can facilitate a customer to schedule an in-person or a web conference consultation. In some embodiments, the scheduling options are available immediately when the customer starts to use the features.

In one embodiment, the system facilitates the customer to consult with a specialist “now”, in which case the system can connect the customer with a specialist at that time. The specialist can select to turn this feature on or off. If the feature is on, the system sends to the specialist a notification that a customer is requesting to speak with them (this can be accomplished, for example, through web conferencing˜similar to how a doctor web conferences with a patient).

If the system receives an indication that the customer selects to schedule a web consultation, the features (hairline style and type, SMP type, pigment color, density, and the like) are available for both the customer and the specialist to work through the design together during a video call. The same type of features for the eyebrows as well.

In one embodiment, the system can facilitate the specialist to track the number of people visiting the application, view sales report from procedures booked and paid for through the application, process payments through the app (with payment platforms such as, for example, Stripe or PayPal), integrate social media (such as platforms, for example, Facebook, Instagram, and the like), integrate with the specialist's website; request the customer to sign waivers, medical and consent forms digitally, track the type of device a person uses to access the application, store the location of user of the application, and/or upload their own logo (for white label branding).

In one embodiment, the system can facilitate the specialist to set prices for different types of micropigmentation and permanent eyebrow procedures. In some embodiments, a list of standard procedures with associated pricing can include SMP Procedures and price ranges such as, for example, only scar treatment $1,900-$2,500; Norwood 2-3 (hairline and crown work only $2,700-$2,900; standard procedure $3,400-$3,900; standard procedure plus scar work $4,300-$5,050; mild Alopecia $3,900-$4,300; severe alopecia (whole head) $4,300-$4,700; women's hair loss $2,500-$4,100; add density (crown) $2,700-$2,900; add density (thinning hair) $3,400-$3,900; microblading and/or microshading procedures and prices ranges can include, for example, microshading ($xx); microblading ($xx); powder brow ($xx); Ombré brow ($xx); microfeathering and microshading ($xx); and microblading and microshading ($xx).

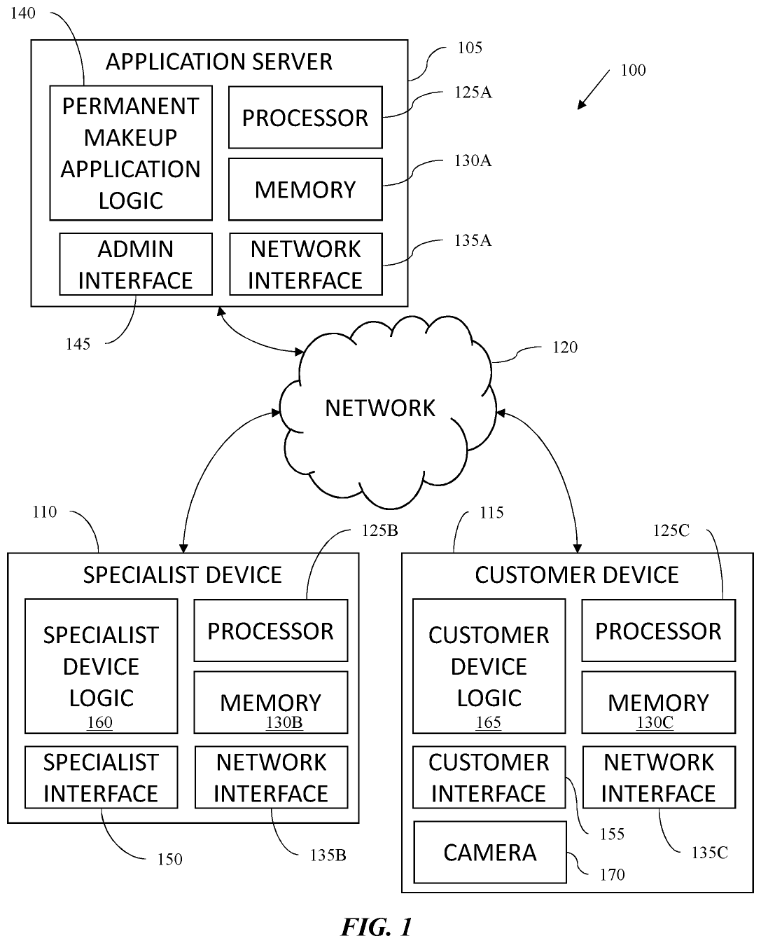

FIG. 1 is a block diagram of computer system 100 which can be used to produce permanent makeup designs according to embodiments of the invention described herein. System 100 can include application server 105 in communication with specialist device 110 and customer device 115 via network 120.

Each of application server 105, specialist device 110, and customer device 115 can be a standalone computer or mobile computing device, mainframe computer system, workstation, network computer, desktop computer, laptop, or the like. Each of application server 105, specialist device 110, and customer device 115 can include: (A) one or more processors 125A, 125B, and 125C, respectively, coupled to memory 130A, 130B, and 130C; (B) network interface 135A, 135B, and 135C to communicate via network 120; and (C) one or more input/output (I/O) devices such as video devices (for example, a camera), audio devices, and displays in operable communication with processors 125A, 125B, 125C and memories 130A, 130B, 130C.

Processors 125A, 125B, 125C suitable for the execution of a computer programs include both general and special purpose microprocessors and any one or more processors of any digital computing device. For instance, processor 125A can receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

Network interface 135A, 135B, 135C may be configured to allow data to be exchanged between application server 105, specialist device 110, and customer device 115 via network 120. In various embodiments, network interface 153B, for example, can support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

Memory 130A can include permanent makeup application logic 140, configured to implement certain embodiments described herein. In one embodiment, the permanent makeup application logic 140 can include computer program modules corresponding to one or more of the various embodiments described herein. For example, permanent makeup application logic can be implemented in various embodiments using any desired programming language, scripting language, or combination of programming languages and/or scripting languages (e.g., C, C++, C#, JAVA®, JAVASCRIPT®, PERL®, and the like).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

The steps and actions of system 100 described in connection with the embodiments disclosed herein may be embodied directly in hardware, in a program module executed by a processor, or in a combination of the two. A program module may reside in RAM, flash memory, ROM memory, EPROM memory, EEPROM memory, registers, a hard disk, a removable disk, a CD-ROM, or any other form of storage medium known in the art. An exemplary storage medium can be coupled to processor 125A, 125B, 125C such that said processor can read information from, and write information to, the respective storage medium. In the alternative, the storage medium may be integrated into said processor. Further, in some embodiments, said processor and the storage medium may reside in an Application Specific Integrated Circuit (ASIC). In the alternative, said processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the system is world-wide-web (www) based, and the network server is a web server delivering HTML, XML, etc., web pages to the computer system. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, permanent makeup application logic 140 includes computer program modules for facilitating the production of a permanent makeup design via the interaction of specialist device 110 and customer device 115. Permanent makeup application logic 140 can include program modules for supporting admin interface 145, specialist interface 150, and/or customer interface 155. Admin interface 145 can provide tools for the configuration and provision of, for example, portals for interaction between application server 105, specialist device 110 and/or customer device 115.

In one embodiment, permanent makeup application logic 140 can include program modules for receiving and storing user profiles associated with specialist device 110 and/or customer device 115. In some embodiments, permanent makeup application logic 140 includes program modules for (A) facilitating the production, receipt, and/or storage of a scan of a subject's head and/or face; (B) determining measurements associated with features of the subject's head and/or face; (C) determining areas of the subject's head/face that can be suitable targets for the application of permanent makeup designs (such targets can include, for example, bald spots, scars, or areas of thinning hair); (D) receiving input in real time from specialist device 110 and/or customer device 115, said input associated with the production of a permanent makeup design; and/or (E) providing an augmented reality filter for displaying images of the subject's head and/or face with designs of permanent makeup.

In some embodiments, specialist device 110 can include specialist device logic 160, which can have program modules for facilitating: (A) interaction between specialist device 110, application server 105, and/or customer device 115 in real time; (B) production, editing, and/or storing of permanent make up designs; (C) management of user profiles associated with customer devices 115; and/or (D) management of various e-commerce tools associated with providing permanent makeup services to customers.

In one embodiment, customer device 115 can include customer device logic 165, which can have program modules for facilitating: (A) interaction between customer device 115, application server 105, and/or specialist device 110 in real time; (B) production, editing, and/or storing of permanent make up designs; (C) management of a user account associated with customer device 115; and/or (D) user interaction with various e-commerce tools associated with receiving permanent makeup services. In some embodiments, customer device 115 can include camera 170 for facilitating the production of images and/or scans of a subject's head and/or face.

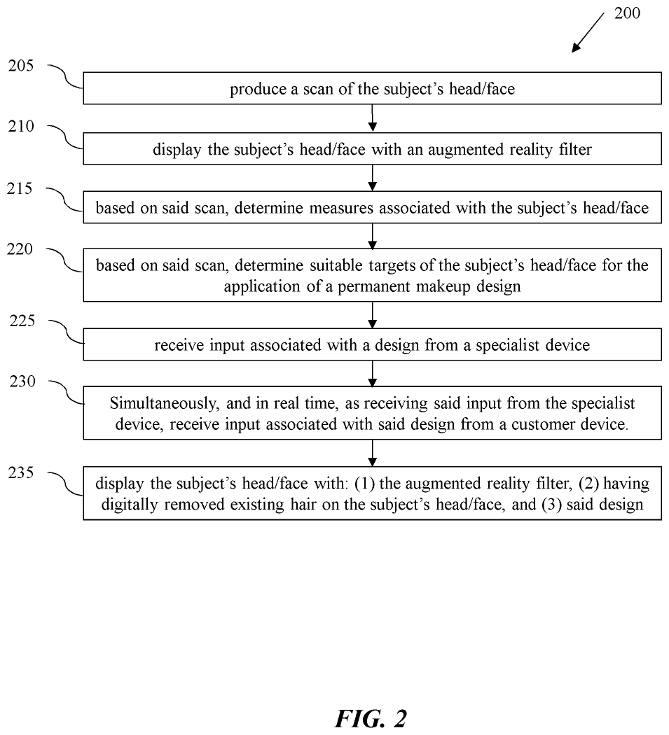

FIG. 2 is a diagram of an exemplary method 200 that can be used to produce a permanent makeup design according to some inventive embodiments disclosed herein. At a step 205, in one embodiment permanent makeup application logic 140 and customer device logic 165 collaborate to facilitate the production of a scan of a subject's head and/or face. Customer device 115 receives via camera 170 one or more images of the subject's head and/or face. Customer interface 155, customer device logic 165, and/or permanent makeup application logic 140 are configured to (A) produce, receive, and/or store said scan (step 205); (B) display the subject's head with an augmented reality filter (step 210); (C) based on said scan, determine one or more measurements associated with the features of the subject's head/face (step 215); and/or (D) determine suitable targets of the subject's head/face for the application of a permanent makeup design (step 220). In some embodiments, for example, the size of the overall head, eyebrows, forehead, and/or mouth of the subject are determined. The size can include, for example, length, width, and/or area. In certain embodiments, suitable targets can include areas of scars, bald spots, discoloration, or thinning hair.

In one embodiment of step 205, a scan of the subject's head/face can be made using a 3D scanning application (such as Trnio, Scann3D, and 3D Creator, for example). The scanning application can be included in, for example, customer device logic 165.

At a step 225, specialist interface 150, specialist device logic 160, and/or permanent makeup application logic 140 facilitate receiving input associated with a permanent makeup design from specialist device 110. In one embodiment, specialist device logic 160 and/or specialist interface 150 facilitate a specialist selecting, adjusting, editing, or the like, various features of a permanent makeup design. For example, in the case of a permanent makeup design for eyebrows, specialist interface 150 can include a user interface having one or more controls for selecting the shape, size, and/or color of the permanent makeup design for the eyebrows. In the case of a permanent makeup design for hair, specialist interface can include a user interface having one for more controls for selecting hairline style and type, SMP type, pigment color, density, and the like.

At a step 230, customer interface 155, customer device logic 165, and/or permanent makeup application logic 140 facilitate receiving input associated with a permanent makeup design from customer device 115. In one embodiment, customer device logic 165 and/or customer interface 155 facilitate a customer selecting, adjusting, editing, or the like, various features of a permanent makeup design. For example, in the case of a permanent makeup design for eyebrows, customer interface 155 can include a user interface having one or more controls for selecting the shape, size, and/or color of the permanent makeup design for the eyebrows. In the case of a permanent makeup design for hair, specialist interface can include a user interface having one for more controls for selecting hairline style and type, SMP type, pigment color, density, and the like.

In certain embodiments, at step 230, system 100 can facilitate use of customer device 115 and specialist device 110 to simultaneously, and in real time, provide input from specialist device 110 and from customer device 115, said input associated with producing the permanent makeup design. For example, via Internet telephony (such as web conferencing, video call, and the like), users of specialist device 110 and customer device 115 can interact in real time, simultaneously, so that a customer user of customer device 115 can provide significant input into the production of the permanent makeup design.

At a step 235, in some embodiments, system 100 can facilitate the display of the subject's head/face with the augmented reality filter and the design produced via the collaboration of a specialist and a customer. In one embodiment, permanent makeup application logic 140 produces one or more images (from various angles) of the subject's head/face showing the permanent makeup design. Application server 105 can send the images to specialist device 110 and/or customer device 115. Specialist interface 150 and/or customer interface 155 can display the images to users of said specialist device 110 and/or customer device 115.

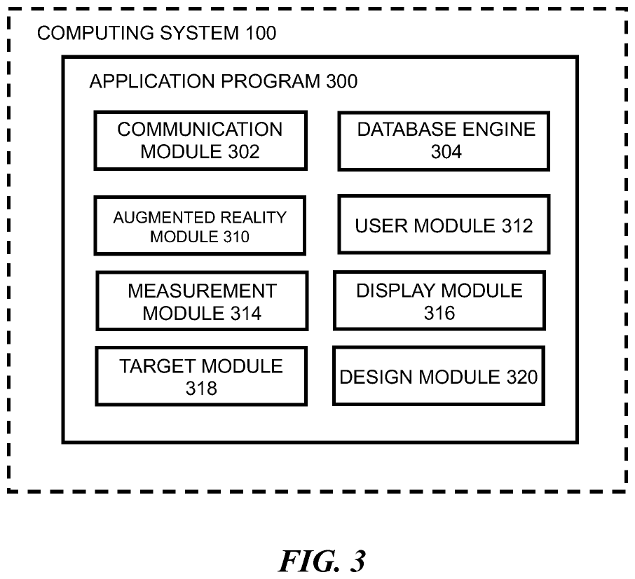

FIG. 3 illustrates an example computer architecture for the application program 300 operated via the computing system 100. The computer system 100 comprises several modules and engines configured to execute the functionalities of the application program 300, and a database engine 304 configured to facilitate how data is stored and managed in one or more databases. In particular, FIG. 2 is a block diagram showing the modules and engines needed to perform specific tasks within the application program 300.

Referring to FIG. 3, the computing system 100 operating the application program 300 comprises one or more modules having the necessary routines and data structures for performing specific tasks, and one or more engines configured to determine how the platform manages and manipulates data. In some embodiments, the application program 300 comprises one or more of a communication module 302, a database engine 304, an augmented reality module 310, a user module 312, a measurement module 314, a display module 316, a target module 318, and a design module 320.

In some embodiments, the communication module 302 is configured for receiving, processing, and transmitting a user command and/or one or more data streams. In such embodiments, the communication module 302 performs communication functions between various devices, including the user computing device, the administrator computing device, and a third-party computing device. In some embodiments, the communication module 302 is configured to allow one or more users of the system, including a third-party, to communicate with one another. In some embodiments, the communications module 302 is configured to maintain one or more communication sessions with one or more servers, the administrative computing device, and/or one or more third-party computing device(s). In some embodiments, the communication module 302 allows each user to transmit and receive information which may be used by the system.

In some embodiments, the communication module 302 facilitates communication between the customer device and the specialist device to provide for simultaneous collaboration, in real time, between a user of the customer device and a user of the specialist device in the creation of the permanent makeup design.

In some embodiments, a database engine 304 is configured to facilitate the storage, management, and retrieval of data to and from one or more storage mediums, such as the one or more internal databases described herein. In some embodiments, the database engine 304 is coupled to an external storage system. In some embodiments, the database engine 304 is configured to apply changes to one or more databases. In some embodiments, the database engine 304 comprises a search engine component for searching through thousands of data sources stored in different locations. The database engine 304 allows each user and module associated with the system to transmit and receive information stored in various databases.

In some embodiments, the augmented reality module 310 is configured to generate an augmented reality filter. The augmented reality module 310 may utilize a scan of the subject's head/face to display the scan.

In some embodiments, the user module 312 facilitates the creation of a user account for the application system. The user module 312 may allow the user to input account information, user profile preferences, imagery, and the like.

In some embodiments, the measurement module 314 is configured to determine measurements associated with the subject's head/face that are used to determine one or more targets.

In some embodiments, the display module 316 is configured to display one or more graphic user interfaces, including, e.g., one or more user interfaces, one or more consumer interfaces, one or more video presenter interfaces, etc. In some embodiments, the display module 316 is configured to temporarily generate and display various pieces of information in response to one or more commands or operations. The various pieces of information or data generated and displayed may be transiently generated and displayed, and the displayed content in the display module 316 may be refreshed and replaced with different content upon the receipt of different commands or operations in some embodiments. In such embodiments, the various pieces of information generated and displayed in a display module 316 may not be persistently stored.

In some embodiments, the target module 318 is configured to receive measurements from the measurement module 314 and determine one or more targets of the subject's head/face for the application of the permanent makeup design.

In some embodiments, the design module 320 receives a specialist input associated with the permanent makeup design.

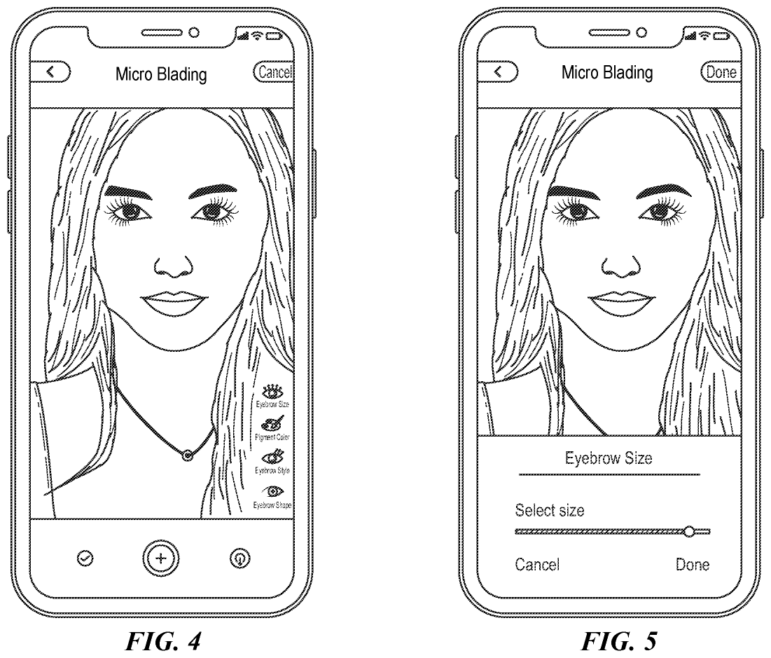

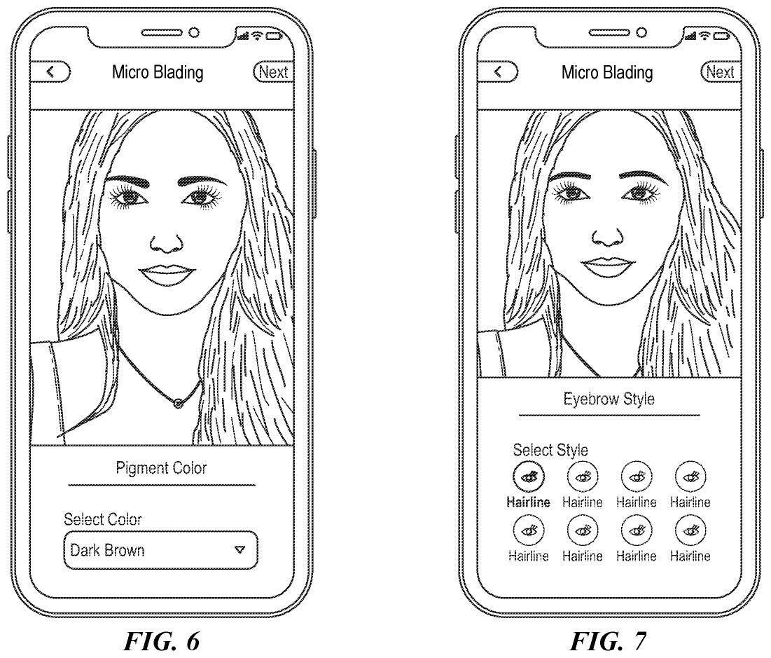

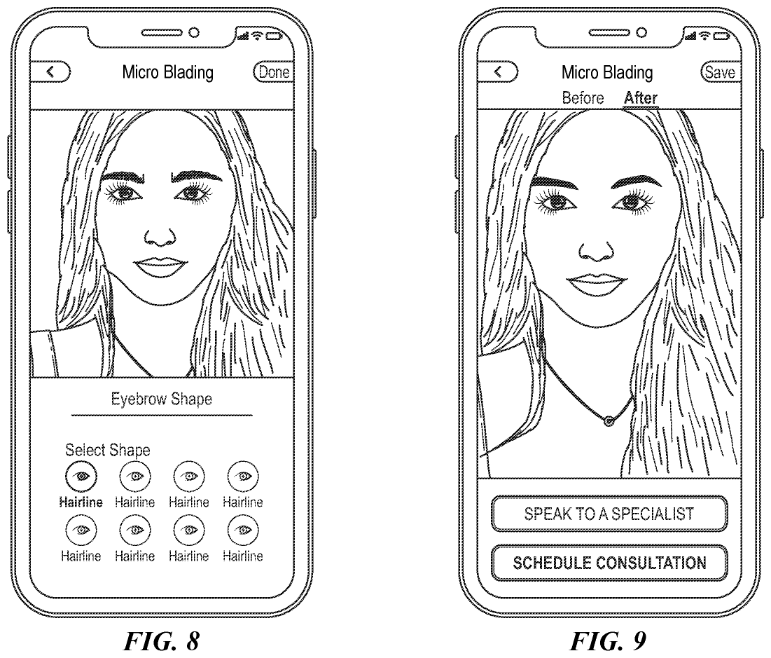

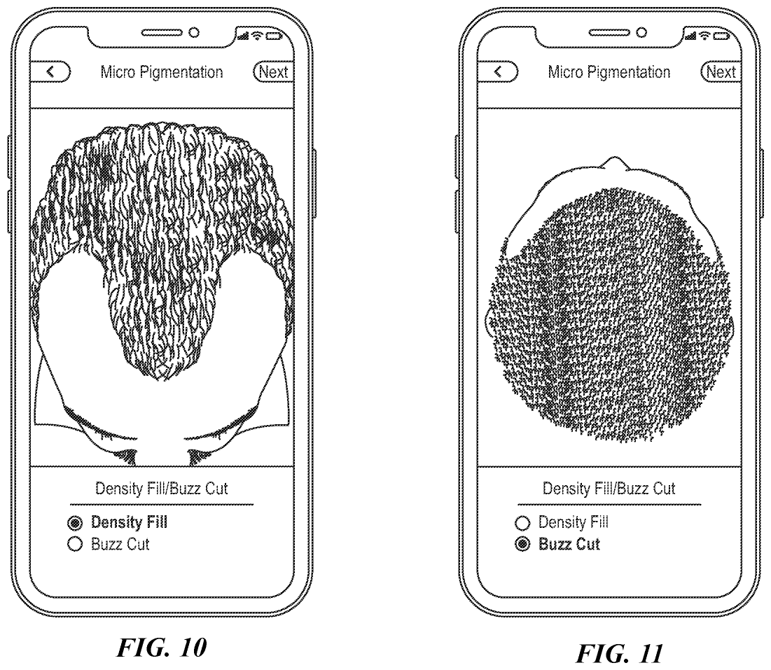

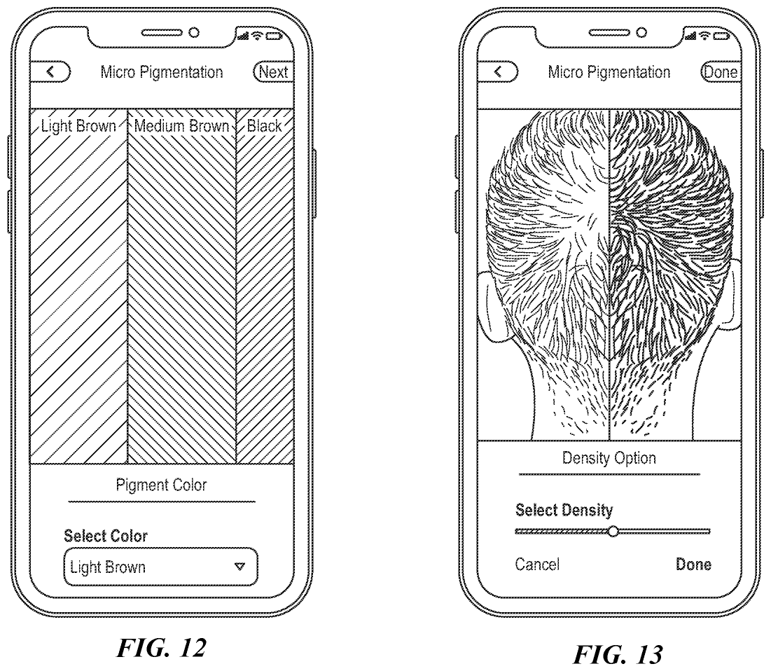

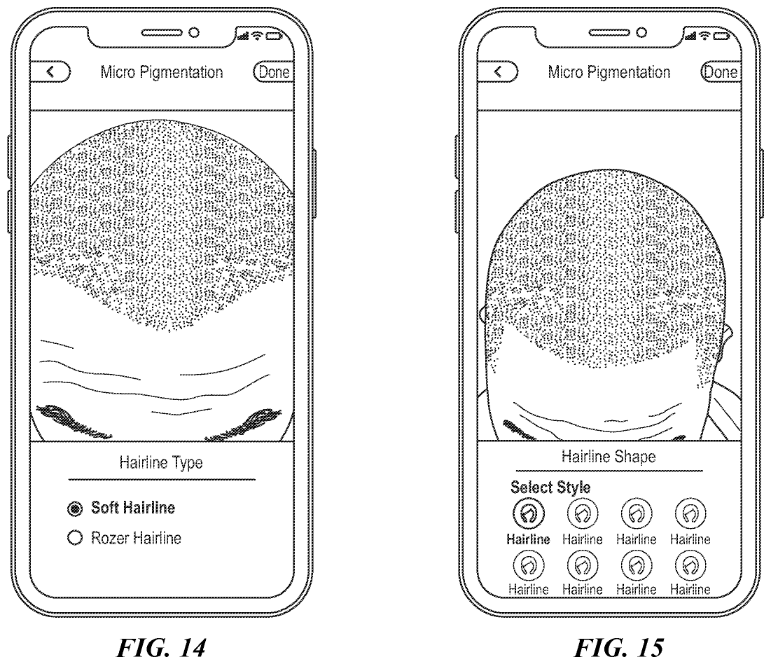

FIGS. 4-15 illustrate the user interface including micro blading interfaces (see FIGS. 4-9) and micro pigmentation (see FIGS. 10-15).

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for producing a permanent makeup design for application to a subject's head/face, the system comprising:
an application server computer having a processor, a memory, and a network interface;
one or more computer program modules stored in said memory;
a display module to display the subject's head with an augmented reality filter, said display performed in communication with a specialist interface of a specialist device and/or a customer interface of a customer device;
an augmented reality module to display the scan on the specialist device or the customer device;
a measurement module to determine measurements associated with the subject's head/face;
a target module to determine one or more targets of the subject's head/face for the application of the permanent makeup design;
receive from the customer interface a customer input associated with the permanent makeup design; and
a design module to receive from the specialist interface a specialist input associated with the permanent makeup design.

2. The system of claim 1, wherein said targets comprise eyebrows, scars, bald spots, or thinning spots on the subject's head/face.

3. The system of claim 1, wherein the customer input and/or the specialist input is associated with an adjustment of size, shape, and/or color of the permanent makeup design.

4. The system of claim 1, further comprising a communication module to facilitate the communication between the specialist device and the customer device.

5. The system of claim 4, wherein the communication module provides for simultaneous collaboration, in real time, between a user of the customer device and a user of the specialist device in the creation of the permanent makeup design.

6. A system for producing a permanent makeup design for application to a subject's head/face, the system comprising:
an application server computer having a processor, a memory, and a network interface;
one or more computer program modules stored in said memory, the modules configured to:
produce a scan of the subject's head;
display the subject's head with an augmented reality filter, said display performed in communication with a specialist interface of a specialist device and/or a customer interface of a customer device;
based on said scanning, determine measurements associated with the subject's head/face;
based on said scanning, determine targets of the subject's head/face for the application of the permanent makeup design;
receive from the customer interface a customer input associated with the permanent makeup design;
receive from the specialist interface a specialist input associated with the permanent makeup design;
facilitate communication between the customer device and the specialist device to provide for simultaneous collaboration, in real time, between a user of the customer device and a user of the specialist device in the creation of the permanent makeup design; and
display the subject's head/face (a) using the augmented reality filter, (b) with the existing hair virtually removed from the subject's head/face, and (c) the permanent makeup design replacing the targets, wherein the display is performed in communication with the specialist device and/or the customer device.

7. The system of claim 6, wherein said targets comprise eyebrows, scars, bald spots, or thinning spots on the subject's head/face.

8. The system of claim 6, wherein the customer input and/or the specialist input is associated with an adjustment of size, shape, and/or color of the permanent makeup design.

9. The system of claim 6, further comprising a communication module to facilitate the communication between the specialist device and the customer device.

10. The system of claim 9, wherein the communication module provides for simultaneous collaboration, in real time, between a user of the customer device and a user of the specialist device in the creation of the permanent makeup design.

11. A method of producing a permanent makeup design for a subject, the method comprising:
producing a scan of the subject's head/face;
displaying the subject's head/face with an augmented reality filter;
based on said scanning, determining measurements associated with the subject's face/head;
based on said scanning, determining targets of the subject's head/face for the application of the permanent makeup design;
providing a customer interface for receiving customer input associated with the permanent makeup design;
providing a specialist interface for receiving specialist input associated with the permanent makeup design;
wherein the customer interface and the specialist interface are configured to facilitate a customer and a specialist to collaborate simultaneously, in real time, in the creation of the design;
wherein the customer input and/or the specialist input are configured to facilitate an adjustment of size, shape, and/or color of the design; and
displaying the subject's head/face (a) using the augmented reality filter, (b) with the existing hair virtually removed, and (c) the permanent makeup design replacing the targets.

12. The method of claim 11, the method further comprising providing a camera for taking a picture of the subject's head/face.

13. The method of claim 11, wherein determining targets comprises determining scars, bald spots, eyebrows, or thinning spots on the subject's head/face.

14. The method of claim 11, wherein the customer input and/or the specialist input is associated with an adjustment of size, shape, and/or color of the permanent makeup design.

15. The method of claim 11, further comprising an augmented reality module to display the scan on the specialist device or the customer device.

16. The method of claim 15, further comprising a measurement module to determine measurements associated with the subject's head/face.

17. The method of claim 16, further comprising a target module to determine one or more targets of the subject's head/face for the application of the permanent makeup design.

18. The method of claim 17, further comprising a design module to receive from the specialist interface a specialist input associated with the permanent makeup design.
